(19) United States
(12) Patent Application Publication
(10) Pub. No.: US 2021/0108127 A1
(43) Pub. Date: Apr. 15, 2021

(54) BETA-GLUCAN COMPOSITIONS AND SHEARING TO PROVIDE VISCOSITY MAINTENANCE THEREOF

(71) Applicant: CARGILL, INCORPORATED, Wayzata, MN (US)

(72) Inventors: Dominique LELIMOUSIN, Cretteville (FR); Jeffrey J. MALSAM, Minneapolis, MN (US); Eric Stanley SUMNER, Minneapolis, MN (US)

(73) Assignee: CARGILL, INCORPORATED, Wayzata, MN (US)

(21) Appl. No.: 16/499,739

(22) PCT Filed: Mar. 28, 2018
(86) PCT No.: PCT/US2018/024792

§ 371 Date: Sep. 30, 2019

Related U.S. Application Data
(60) Provisional application No. 62/477,648, filed on Mar. 28, 2017.

(51) Int. Cl. C09K 8/588; C08B 37/00

(52) U.S. Cl. CPC C09K 8/588; C08B 37/0024

(57) ABSTRACT

Beta-glucan compositions and methods of making and using the same, such as for treatment of a subterranean formation. A beta-glucan composition includes a beta-glucan and water. Shearing the beta-glucan composition at a shear rate of up to a maximum shear rate of about 300,000 s⁻¹ or less provides a sheared beta-glucan composition having a viscosity at standard temperature and pressure at 6 rpm of at least about 30 cps and a Filterability Ratio of less or equal to than about 1.5.

### BACKGROUND

Beta-glucans can be used as thickeners in aqueous fluids for treatment of subterranean formations, such as for enhanced oil recovery (EOR). Controlling viscosity and filterability (e.g., resistance to clogging of subterranean formation pores) of aqueous compositions including conventional beta-glucans can be difficult and inconvenient, with compositions having acceptable filterabilities often having lower than desired viscosities.

### SUMMARY OF THE INVENTION

The present invention provides a beta-glucan composition. The beta-glucan composition can include a beta-glucan and water. Shearing the beta-glucan composition at a shear rate of up to a maximum shear rate of about 300,000 s⁻¹ or less can provide a sheared beta-glucan composition having a viscosity at standard temperature and pressure at 6 rpm of at least about 30 cps and a Filterability Ratio of less or equal to than about 1.5.

The present invention provides a beta-glucan composition including a beta-glucan that is scleroglucan, schizophyllan, or a combination thereof, having a particle size of about 100 microns to about 500 microns. The beta-glucan can be about 0.01 wt % to about 3 wt % of the beta-glucan composition. The beta-glucan composition can also include water that is about 95 wt % to about 99.99 wt % of the beta-glucan composition, wherein the water and the beta-glucan are homogeneous. Shearing the beta-glucan composition at a shear rate of about 50,000 s⁻¹ to about 250,000 s⁻¹ for a duration of at least 0.01 s can provide a sheared beta-glucan composition having a viscosity at standard temperature and pressure at 6 rpm of about 30 cps to about 150 cps and a Filterability Ratio of about 1.01 to about 1.5.

The present invention provides a prepared beta-glucan composition. The prepared beta-glucan composition can include a beta-glucan and water, can have a viscosity at standard temperature and pressure at 6 rpm of at least about 30 cps, and can have a Filterability Ratio of less or equal to than about 1.5. In various aspects, the prepared beta-glucan composition can be the sheared beta-glucan composition formed by shearing the beta-glucan composition described herein.

The present invention provides a method of forming the prepared beta-glucan composition described herein. The method can include applying to the beta-glucan composition described herein a shear rate of less than or equal to the maximum shear rate, to form the sheared beta-glucan composition.

The present invention provides a method of treating a subterranean formation. The method can include placing the beta-glucan composition described herein in the subterranean formation.

The present invention provides a method of treating a subterranean formation. The method can include placing the prepared beta-glucan composition described herein in the subterranean formation. The prepared beta-glucan composition can be the sheared beta-glucan composition formed by shearing the beta-glucan composition described herein.

The present invention provides a method of treating a subterranean formation. The method can include shearing the beta-glucan composition described herein a shear rate of less than or equal to the maximum shear rate, to form a sheared beta-glucan composition. The method can include placing the sheared beta-glucan composition in the subterranean formation.

The present invention provides a method of treating a subterranean formation. The method can include placing the prepared beta-glucan composition described herein in the subterranean formation, wherein in various aspects, the prepared beta-glucan composition can be the sheared beta-glucan composition formed by shearing the beta-glucan composition described herein. The method can include maintaining viscosity of the prepared beta-glucan composition including applying a shear rate of about 50,000 s⁻¹ to about 250,000 s⁻¹ for a duration of at least 0.01 s.

The beta-glucan compositions of the present invention and methods of making and using the same can have certain advantages over other beta-glucan compositions and methods relating to the same, at least some of which are unexpected. For example, various aspects of the beta-glucan composition of the present invention can be sheared to provide convenient and customizable viscosity and filterability, such as for treatment of subterranean formations. In various aspects, a reasonable Filterability Ratio of the inventive beta-glucan composition can be maintained with higher viscosity than other beta-glucan compositions having a comparable Filterability Ratio, which can provide enhanced control over mobility during various methods of treating subterranean formations while decreasing or eliminating clogging of the pores of the subterranean formation (e.g., maintaining permeability), such as during an enhanced oil recovery operation.

In various aspects, the ability of the viscosity of the beta-glucan composition to be maintained at low or medium shear can help maintain viscosity during treatment of subterranean formations. In various aspects, the ability of the viscosity of the beta-glucan composition to be maintained at low or medium shear and can help to avoid fingering such as at pore openings where shear can be low. In various aspects, the beta-glucan composition can have shear thinning behavior that allows it to resist flow in open pore zones while not creating excess resistance in small pores.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “standard temperature and pressure” as used herein refers to 20° C. and 101 kPa.

The term “downhole” as used herein refers to under the surface of the earth, such as a location within or fluidly connected to a wellbore.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, water shut-off, conformance, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some aspects, a flow pathway can be a water source and can include water. In some aspects, a flow pathway can be a petroleum source and can include petroleum. In some aspects, a flow pathway can be sufficient to divert from a wellbore, fracture, or flow pathway connected thereto at least one of water, a downhole fluid, or a produced hydrocarbon.

### Beta-Glucan Composition.

The present invention provides a beta-glucan composition. The beta-glucan composition can include a beta-glucan and water (e.g., a homogeneous mixture thereof, or a heterogeneous mixture thereof). Shearing the beta-glucan composition at a shear rate of up to a maximum shear rate of about 300,000 s⁻¹ or less can provide a sheared beta-glucan composition including a viscosity at standard temperature and pressure at 6 rpm of at least about 30 cps and a Filterability Ratio of less or equal to than about 1.5. The beta-glucan composition is not required to be sheared; rather, the properties of a sheared beta-glucan composition provided by shearing the beta-glucan composition at a shear rate of up to the maximum shear rate is merely a way to characterize the beta-glucan composition.

The shearing of the beta-glucan composition to form the sheared beta-glucan composition (e.g., also referred to herein as the “prepared” beta-glucan composition) can be any suitable shearing under any suitable conditions that provides the sheared beta-glucan composition described herein and that is up to the maximum shear rate (e.g., free of shearing at a shear rate above the maximum shear rate). The shearing of the beta-glucan composition at the shear rate up to the maximum shear rate can include shearing the beta-glucan composition at a shear rate equal to the maximum shear rate. The shearing of the beta-glucan at the shear rate up to the maximum shear rate can include shearing the beta-glucan composition at a shear rate of about 40,000 s⁻¹ to about 300,000 s⁻¹, about 50,000 s⁻¹ to about 250,000 s⁻¹, about 100,000 s⁻¹ to about 200,000 s⁻¹, or about 40,000 s⁻¹ or less, or less than, equal to, or greater than 50,000 s⁻¹, 60,000, 70,000, 80,000, 90,000, 100,000, 110,000, 120,000, 130,000, 140,000, 150,000, 160,000, 170,000, 180,000, 190,000, 200,000, 210,000, 220,000, 230,000, 240,000, 250,000, 260,000, 270,000, 280,000, 290,000, or about 300,000 s⁻¹ or more. The shearing of the beta-glucan composition at the shear rate up to the maximum shear rate can include shearing the beta-glucan composition for any suitable duration, such as for at least 0.001 seconds (s), 0.01 s, 0.1 s, 0.2 s, 0.3 s, or at least about 1 s or more, or for up to about 60 s, 30 s, 10 s, 5 s, or up to about 3 s or less. The shearing can be performed for a duration of about 0.001 seconds to about 60 seconds, about 0.01 second to about 5 seconds, or about 0.001 seconds or less, or less than, equal to, or greater than about 0.01 s, 0.1, 1, 2, 3, 4, 5, 10, 15, 20, 25, 30, 35, 40, 45, 50, 55, 60 s, 2 minutes, 5, 10, 30 minutes, or about 1 hour or more. The shearing can be performed at any suitable temperature, such as at an ambient temperature above-surface or downhole, such as at a temperature of about 0° C. to about 150° C., about 20° C. to about 50° C., about 0° C. or less, or less than, equal to, or greater than about 10° C., 20, 30, 40, 50, 60, 70, 80, 90, 100, 110, 120, 130, 140° C., or about 150° C. or more. The shearing can be performed at any suitable pressure, such as a pressure of about 0.1 MPa to about 100 MPa, about 0.1 MPa to about 1 MPa, or about 0.1 MPa or less, or less than, equal to, or greater than about 0.5 MPa, 1, 2, 3, 4, 5, 10, 20, 50, or about 100 MPa or more.

The viscosity of the sheared beta-glucan composition at 6 rpm can be about 30 cps to about 150 cps, or about 50 cps to about 100 cps, or about 30 cps or less, or less than, equal to, or greater than about 35 cps, 40, 45, 50, 55, 60, 65, 70, 75, 80, 85, 90, 95, 100, 105, 110, 115, 120, 125, 130, 135, 140, 145 cps, or about 150 cps or more.

The Filterability Ratio of the sheared beta-glucan composition can be about 1.01 to about 1.5, or about 1.08 to about 1.25, or about 1, or about 1.01 or less, or less than, equal to, or greater than about 1.02, 1.04, 1.06, 1.08, 1.10, 1.12, 1.14, 1.16, 1.18, 1.20, 1.22, 1.24, 1.26, 1.28, 1.3, 1.32, 1.34, 1.36, 1.38, 1.4, 1.42, 1.44, 1.46, 1.48, or about 1.5 or more. The Filterability Ratio can be determined by the procedure described in the Examples. The Filterability Ratio indicates the degree to which the mixture causes pore clogging over time, and is a ratio of time required for 20 g flow at a steady pressure through a filter at a later time divided by the time required for 20 g flow through the filter at an earlier time, with a ratio of 1 indicating no pore clogging (e.g., equal times required for flow at later and earlier times through the same filter at the same pressure). The Filterability Ratio can be determined by passing the sample through a filter having a pore size of about 1.2 microns (e.g., 47 mm diameter, 1.2 μm pore size, EMD Millipore mixed cellulose esters filter (part #RAWP4700)) using a pressure to achieve a flux of about 1-3 g/s and maintaining such pressure consistently while measuring the mass of filtrate produced. The Filterability Ratio is (time (180 g)−time (160 g))/(time (80 g)−time (60 g)). Prior to passing the sample through the 1.2 micron filter, the sample can first be optionally passed through a filter having a pore size of about 2 microns (e.g., 47 mm diameter Millipore AP25 filter (AP2504700)) at about 100-300 mL/min.

The viscosity and Filterability Ratio of the sheared beta-glucan composition can be measured after the application of the shearing and prior to any filtration of the beta-glucan composition; in other examples, the viscosity and Filterability Ratio of the sheared beta-glucan composition can be measured after filtration or after any suitable processing of the sheared beta-glucan composition.

The sheared beta-glucan composition can be prepared by subjecting the beta-glucan composition to a shear rate up to a maximum shear rate of, or to a shear rate equal to, about 150,000 s⁻¹ to about 250,000 s⁻¹, or about 200,000 s⁻¹, or about 150,000 s⁻¹ or less, or less than, equal to, or greater than about 160,000 s⁻¹, 170,000, 180,000, 190,000, 200,000, 210,000, 220,000, 230,000, 240,000 s⁻¹, or about 250,000 s⁻¹ or more. The viscosity of such a sheared beta-glucan composition measured at standard temperature and pressure and at 6 rpm can be about 30 cps to about 80 cps, or about 40 cps to about 60 cps, or about 30 cps or less, or less than, equal to, or greater than about 35 cps, 40, 45, 50, 55, 60, 65, 70, 75 cps, or about 80 cps or more. The Filterability Ratio of such a sheared beta-glucan composition can be about 1.1 to about 1.5, or about 1.2 to about 1.3, or about 1.1 or less, or less than, equal to, or greater than about 1.1, 1.15, 1.2, 1.25, 1.3, 1.35, 1.4, 1.45, or about 1.5 or more.

The sheared beta-glucan composition can be prepared by subjecting the beta-glucan composition to a shear rate up to a maximum shear rate of, or to a shear rate equal to, about 110,000 s⁻¹ to about 210,000 s⁻¹, about 160,000 s⁻¹, or about 110,000 s⁻¹ or less, or less than, equal to, or greater than about 120,000 s⁻¹, 130,000, 140,000, 150,000, 160,000, 170,000, 180,000, 190,000, 200,000 s⁻¹, or about 210,000 s⁻¹ or more. The viscosity of such a sheared beta-glucan composition measured at standard temperature and pressure and at 6 rpm can be about 60 cps to about 120 cps, or about 80 cps to about 100 cps, or about 60 cps or less, or less than, equal to, or greater than about 65 cps, 70, 75, 80, 85, 90, 95, 100, 105, 110, 115 cps, or about 120 cps or more. The Filterability Ratio of such a sheared beta-glucan composition can be about 1.1 to about 1.3, or about 1.15 to about 1.25, or about 1.1 or less, or less than, equal to, or greater than about 1.15, 1.2, 1.25, or about 1.3 or more.

The sheared beta-glucan composition can be prepared by subjecting the beta-glucan composition to a shear rate up to a maximum shear rate of, or to a shear rate equal to, about 50,000 s⁻¹ to about 150,000 s⁻¹, about 100,000 s⁻¹, or about 50,000 s⁻¹ or less, or less than, equal to, or greater than about 60,000 s⁻¹, 70,000, 80,000, 90,000, 100,000, 110,000, 120,000, 130,000, 140,000 s⁻¹, or about 150,000 s⁻¹ or more. The viscosity of such a sheared beta-glucan composition measured at standard temperature and pressure and at 6 rpm can be about 70 cps to about 130 cps, or about 90 cps to about 110 cps, or about 70 cps or less, or less than, equal to, or greater than about 75, 80, 85, 90, 95, 100, 105, 110, 115, 120, 125 cps, or about 130 cps or more. The Filterability Ratio of such a sheared beta-glucan composition can be about 1 to about 1.2, or about 1.05 to about 1.15, or about 1, or about 1.01 or less, or less than, equal to, or greater than about 1.05, 1.1, 1.15, or about 1.2 or more.

The beta-glucan composition can include one or more beta-glucans. The one or more beta-glucans can be any suitable proportion of the beta-glucan composition, such as about 0.001 wt % to about 10 wt % of the beta-glucan composition, about 0.01 wt % to about 3 wt % of the beta-glucan composition, or about 0.001 wt % or less, or less than, equal to, or greater than about 0.01 wt %, 0.05, 0.1, 0.2, 0.3, 0.4, 0.5, 0.6, 0.8, 1, 1.5, 2, 2.5, 3, 4, 5, 6, 7, 8, 9 wt %, or about 10 wt % or more.

The beta-glucan can be any suitable beta-glucan that can form the beta-glucan composition described herein. The beta-glucan can be a 1,3 beta-glucan. The beta-glucan can be a 1,3-1,6 beta-D-glucan. The beta-glucan can be a 1,3-1,4 beta-D-glucan, such as having a main chain from beta-1,3-glycosidically bonded glucose units, and side groups which are formed from glucose units and are beta-1,6-glycosidically bonded thereto. Examples of such 1,3 beta-D-glucans include curdlan (a homopolymer of beta-(1,3)-linked D-glucose residues produced from, e.g., Agrobacterium spp.), grifolan (a branched beta-(1,3)-D-glucan produced from, e.g., the fungus Grifola frondosa), lentinan (a branched beta-(1,3)-D-glucan having two glucose branches attached at each fifth glucose residue of the beta-(1,3)-backbone produces from, e.g., the fungus Lentinus eeodes), schizophyllan (a branched beta-(1,3)-D-glucan having one glucose branch for every third glucose residue in the beta-(1,3)-backbone produced from, e.g., the fungus Schizophyllan commune), scleroglucan (a branched beta-(1,3)-D-glucan with one out of three glucose molecules of the beta-(1,3)-backbone being linked to a side D-glucose unit by a (1,6)-beta bond produced from, e.g., fungi of the Sclerotium spp.), SSG (a highly branched beta-(1,3)-glucan produced from, e.g., the fungus Sclerotinia sclerotiorum), soluble glucans from yeast (a beta-(1,3)-D-glucan with beta-(1,6)-linked side groups produced from, e.g., Saccharomyces cerevisiae), laminarin (a beta-(1,3)-glucan with beta-(1,3)-glucan and beta-(1,6)-glucan side groups produced from, e.g., the brown algae Laminaria digitata), and cereal glucans such as barley beta glucans (linear beta-(1,3)(1,4)-D-glucan produced from, e.g., Hordeum vulgare, Avena sativa, or Triticum vulgare).

The beta-glucan can be scleroglucan, a branched BG with one out of three glucose molecules of the beta-(1,3)-backbone being linked to a side D-glucose unit by a (1,6)-beta bond produced from, e.g., fungi of the Sclerotium. The beta-glucan can be schizophyllan, a branched BG having one glucose branch for every third glucose residue in the beta-(1,3)-backbone produced from, e.g., the fungus Schizophyllan commune. The beta-glucan can have any suitable particle size, such as a particle size (e.g., largest dimension) of about 10 microns to about 1,000 microns, about 100 microns to about 500 microns, or about 10 microns or less, or less than, equal to, or greater than about 20 microns, 30, 40, 50, 60, 70, 80, 90, 100, 120, 140, 160, 180, 200, 220, 240, 250, 260, 280, 300, 350, 400, 450, 500, 600, 700, 800, 900, or about 1,000 microns or more. The particle size can be an average particle size (e.g., number average). Fungal strains that secrete such glucans are known to those skilled in the art. Examples include Schizophyllum commune, Sclerotium rolfsii, Sclerotium glucanicum, Monilinla fructigena, Lentinula edodes, or Botrygs cinera. The beta-glucan can have desirable characteristics for treatment of subterranean formations as described in co-pending patent applications U.S. Provisional Application Ser. Nos. 62/313,973, 62/313,988, 62/345,109, and 62/348,278, and U.S. Patent Publication No. 2012/0205099.

The water can be any suitable proportion of the beta-glucan composition, such as about 70 wt % to about 99.999 wt %, or about 95 wt % to about 99.99 wt %, or about 70 wt % or less, or less than, equal to, or greater than about 75 wt %, 80, 82, 84, 86, 88, 90, 91, 92, 93, 94, 95, 96, 97, 98, 99, 99.9, 99.99 wt %, or about 99.999 wt % or more. The water can include fresh water, salt water, brine, produced water, flowback water, brackish water, sea water, synthetic sea water, or a combination thereof. For a salt water, the one or more salts therein can be any suitable salt, such as at least one of NaBr, CaC₂, CaBr₂, ZnBr₂, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof. The water can have any suitable total dissolved solids level, such as about 1,000 mg/L to about 250,000 mg/L, or about 1,000 mg/L or less, or about 0 mg/L, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The water can have any suitable salt concentration, such as about 1,000 ppm to about 300,000 ppm, or about 1,000 ppm to about 150,000 ppm, or about 0 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, or about 300,000 ppm or more. In some examples, the water can have a concentration of at least one of NaBr, CaCl₂), CaBr₂, ZnBr₂, KCl, and NaCl of about 0.1% w/v to about 20% w/v, or about 0%, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more.

The beta-glucan composition can include one or more organic solvents. The beta-glucan composition can be substantially free of organic solvents. The one or more organic solvents can be any suitable proportion of the beta-glucan composition, such as about 0.001 wt % to about 30 wt %, or about 0.01 wt % to about 5 wt %, or about 0.001 wt % or less, or less than, equal to, or greater than about 0.01 wt %, 0.1, 0.2, 0.3, 0.4, 0.5, 0.6, 0.8, 1, 1.2, 1.4, 1.6, 1.8, 2, 2.5, 3, 3.5, 4, 4.5, 5, 6, 7, 8, 9, 10, 12, 14, 16, 18, 20, 25, or about 30 wt % or more. The one or more organic solvents can independently be miscible (e.g., fully miscible) or immiscible with the water in the beta-glucan composition. The organic solvent can be any suitable organic solvent that can be used to form the beta-glucan composition described herein, such as an alcohol, an alpha-hydroxy acid alkyl ester, a polyalkylene glycol alkyl ether, or a combination thereof.

### Prepared Beta-Glucan Composition.

The present invention provides a prepared beta-glucan composition. The prepared beta-glucan composition can be any suitable composition that includes a beta-glucan and water, and that has a viscosity at standard temperature and pressure at 6 rpm of at least about 30 cps and a Filterability Ratio of less or equal to than about 1.5.

The prepared beta-glucan composition can be the beta-glucan composition described herein that has been sheared, such as at a shear rate of up to a maximum shear rate of about 300,000 s⁻¹ or less, to provide the prepared (e.g., sheared) beta-glucan composition. The beta-glucan composition can include a beta-glucan and water. The beta-glucan composition can be sheared at a shear rate of up to a maximum shear rate of about 300,000 s⁻¹ or less to provide a sheared beta-glucan composition having a viscosity at standard temperature and pressure at 6 rpm of at least about 30 cps, and a Filterability Ratio of less or equal to than about 1.5.

### Method of Forming the Prepared Beta-Glucan Composition.

The present invention provides a method of forming the prepared beta-glucan composition. The method can be any suitable method that forms the prepared beta-glucan composition described herein. The method can include shearing the beta-glucan composition described herein. For example, the method can include shearing the beta-glucan composition at a shear rate of up to a maximum shear rate of about 300,000 s⁻¹ or less to provide the prepared (e.g., sheared) beta-glucan composition. The beta-glucan composition can include a beta-glucan and water. The beta-glucan composition can be sheared at a shear rate of up to a maximum shear rate of about 300,000 s⁻¹ or less to provide a sheared beta-glucan composition having a viscosity at standard temperature and pressure at 6 rpm of at least about 30 cps, and a Filterability Ratio of less or equal to than about 1.5.

### Method of Treating a Subterranean Formation.

The present invention provides a method of treating a subterranean formation. The method can include placing the beta-glucan composition described herein, the prepared beta-glucan composition described herein (e.g., a sheared beta-glucan composition), or a combination thereof, in the subterranean formation. As used herein, placing a composition in a subterranean formation can designate transporting the composition from above-surface to the subterranean formation, or can designate forming the composition within the subterranean formation. For example, placing a prepared beta-glucan composition in a subterranean formation can designate providing the prepared beta-glucan composition (e.g, a sheared beta-glucan composition) above surface and placing it downhole into the subterranean formation, or it can designate forming the prepared beta-glucan composition in the subterranean formation, such as by shearing the beta-glucan composition described herein downhole. The method of treating the subterranean formation can include performing enhanced oil recovery (e.g., using the prepared beta-glucan composition as a polymer flooding or sweep fluid), hydraulic fracturing, water shut-off, conformance, or a combination thereof. In a hydraulic fracturing operation, the prepared beta-glucan composition can be used during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or at a slurry stage of the fracturing (e.g., as viscous fluid including proppant).

The present invention provides a method of treating a subterranean formation including placing a beta-glucan composition in the subterranean formation, such as the beta-glucan composition described herein. The beta-glucan composition can include a beta-glucan and water. The beta-glucan composition can be sheared at a shear rate of up to a maximum shear rate of about 300,000 s⁻¹ or less to provide a sheared beta-glucan composition having a viscosity at standard temperature and pressure at 6 rpm of at least about 30 cps, and a Filterability Ratio of less or equal to than about 1.5.

The present invention provides a method of treating a subterranean formation including placing a prepared beta-glucan composition in the subterranean formation, such as any prepared beta-glucan composition described herein. The prepared beta-glucan composition can include a beta-glucan and water, and can have a viscosity at standard temperature and pressure at 6 rpm of at least about 30 cps and a Filterability Ratio of less or equal to than about 1.5. The prepared beta-glucan composition can be the beta-glucan composition described herein that has been sheared at a shear rate of up to a maximum shear rate of about 300,000 s⁻¹ or less to provide the prepared (e.g., sheared) beta-glucan composition. In some aspects, the prepared beta-glucan composition can be prepared prior to onset of the method (e.g., above-surface or downhole). In some aspects, placing the prepared beta-glucan composition in the subterranean formation can include placing the beta-glucan composition in the subterranean formation and shearing the beta-glucan composition to form the prepared beta-glucan composition in the subterranean formation, shearing the beta-glucan composition above-surface to form the prepared beta-glucan composition and subsequently placing the sheared beta-glucan composition in the subterranean formation, or a combination thereof.

The present invention provides a method of treating a subterranean formation including shearing the beta-glucan composition described herein at a shear rate of up to a maximum shear rate of about 300,000 s⁻¹ or less to provide a sheared beta-glucan composition including water and a beta-glucan, and having a viscosity at standard temperature and pressure at 6 rpm of at least about 30 cps, and a Filterability Ratio of less or equal to than about 1.5. The shearing to form the sheared beta-glucan composition can be performed above-surface, downhole, or a combination thereof. The method can include placing the sheared beta-glucan composition in the subterranean formation.

The method of treating the subterranean formation can include determining permeability of the subterranean formation. The method can include shearing the beta-glucan composition at up to a maximum shear rate, wherein the maximum shear rate corresponds to a Filterability Ratio that corresponds to the determined permeability (e.g., that is low enough to efficiently permeate the subterranean formation). Such a method can allow maximization of viscosity of the sheared beta-glucan composition while maintaining the Filterability Ratio at levels appropriate for the particular subterranean formation being treated, such as during enhanced oil recovery procedures.

The method of treating the subterranean formation with the beta-glucan composition, with a prepared (e.g., sheared) beta-glucan composition, or a combination thereof, can include performing an enhanced oil recovery procedure in the subterranean formation using the prepared beta-glucan composition. The enhanced oil recovery procedure can include polymer flooding. The method can include using the prepared beta-glucan composition in the subterranean formation to sweep petroleum in the subterranean formation toward a well (e.g., a different well from a well the beta-glucan composition or the prepared beta-glucan composition was originally placed in). The method can include removing the petroleum from the well (e.g., at least some of the petroleum that was swept toward the well).

The present invention provides a method of treating a subterranean formation including placing the prepared (e.g., sheared) beta-glucan composition in the subterranean formation (e.g., such as by shearing the beta-glucan composition and then placing the prepared beta-glucan composition downhole, or by shearing the beta-glucan composition downhole). The method can include maintaining viscosity of the prepared beta-glucan composition including applying a shear rate of about 50,000 s⁻¹ to about 250,000 s⁻¹ (e.g., about 40,000 s⁻¹ to about 300,000 s⁻¹, about 50,000 s⁻¹ to about 250,000 s⁻¹, about 100,000 s⁻¹ to about 200,000 s⁻¹, or about 40,000 s⁻¹ or less, or less than, equal to, or greater than 50,000 s⁻¹, 60,000, 70,000, 80,000, 90,000, 100,000, 110,000, 120,000, 130,000, 140,000, 150,000, 160,000, 170,000, 180,000, 190,000, 200,000, 210,000, 220,000, 230,000, 240,000, 250,000, 260,000, 270,000, 280,000, 290,000, or about 300,000 s⁻¹ or more) for a duration of at least 0.01 s (e.g., about 0.001 seconds to about 60 seconds, about 0.01 second to about 5 seconds, or about 0.001 seconds or less, or less than, equal to, or greater than about 0.01 s, 0.1, 1, 2, 3, 4, 5, 10, 15, 20, 25, 30, 35, 40, 45, 50, 55, 60 s, 2 minutes, 5, 10, 30 minutes, or about 1 hour or more). The prepared beta-glucan composition placed in the subterranean formation can have an original viscosity, and the viscosity of the prepared beta-glucan composition in the subterranean formation is maintained within about 50% to about 100% of the original viscosity (e.g., about 50% or less, or less than, equal to, or greater than 55%, 60, 65, 70, 75, 80, 85, 90, 91, 92, 93, 94, 95, 96, 97, 98, 99, 99.9%, or about 99.99% or more). For example, the method can include maintaining the viscosity of the prepared beta-glucan composition in the subterranean formation at about 30 cps to about 150 cps as measured at standard temperature and pressure at 6 rpm (e.g., about 50 cps to about 100 cps, or about 30 cps or less, or less than, equal to, or greater than about 35 cps, 40, 45, 50, 55, 60, 65, 70, 75, 80, 85, 90, 95, 100, 105, 110, 115, 120, 125, 130, 135, 140, 145 cps, or about 150 cps or more). The maintaining of the viscosity can further include maintaining the Filterability Ratio of the prepared beta-glucan composition. The prepared beta-glucan composition placed in the subterranean formation can have an original Filterability Ratio, wherein the Filterability Ratio of the prepared beta-glucan composition in the subterranean ratio is maintained within about 50% to about 100% of the original filterability ratio (e.g., about 50% or less, or less than, equal to, or greater than 55%, 60, 65, 70, 75, 80, 85, 90, 91, 92, 93, 94, 95, 96, 97, 98, 99, 99.9%, or about 99.99% or more). For example, the method can include maintaining the Filterability Ratio of the prepared beta-glucan composition in the subterranean formation is maintained to about 1.01 to about 1.5.

### EXAMPLES

Various aspects of the present invention can be better understood by reference to the following Examples which are offered by way of illustration. The present invention is not limited to the Examples given herein.

### Part I. Beta-Glucan Preparation

### Example I-1. Beta-Glucan Preparation from Commercial Material

Using a 5000 liter jacketed vessel with moderate agitation, 7 g/L of commercial Actigum® CS6 from Cargill (crude powder blend of scleroglucan and Sclerotium rolfsii organism powder) was added to 2400 liters of 11.8° C. water and mixed for 1 hour. After an hour of mixing, the vessel was heated to 85° C. and left under agitation for 12 hours without temperature control. After 12 hours the temperature was 41.3° C. and the vessel was reheated to 80° C. and passed through a Guerin homogenizer at 200 bar of pressure and 300 L/hr.

The homogenized mixture was cooled to 50° C. 4 g/L of CaC₂*2H₂O was added. pH was reduced to 1.81 using 20% HCl. This mixture was agitated for 30 minutes to enable precipitation of oxalic acid (i.e., as calcium oxalate).

After maturation, the solution was adjusted back to 5.62 pH using 10% Na₂CO₃ and heated to 85° C. and left under agitation without temperature control for 14 hours, then reheated to 80° C.

After reaching 80° C. 20 g/L of Dicalite 4158 filter aid (water permeability 1.4 Darcies to 3.8 Darcies) was added to the vessel and mixed for 10 minutes.

After mixing, the solution was fed to a clean Choquenet 12 m² press filter with Sefar Fyltris 25080 AM filter cloths at 1400 L/hr recycling the product back to the feed tank for 10 minutes. The filter cloths had sufficient pore size to prevent passage of the filter aid. At the end of recycle, the flow was adjusted to 1300 L/hr and passed through the filter. Once the tank was empty an additional 50 liters of water was pushed into the filter. The fluid from this water flush and a 12 bar compression of the cake were both added to the collected permeate. The filter was cleaned after use.

The filtered permeate, water flush, and compression fluid was agitated and heated back to 80° C.

The heated mixture had 6 kg of Dicalite 4158 added thereto and was mixed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1400 L/hr.

Without cleaning the filter, 5.33 g/L of Clarcel® DICS (water permeability 2.4 Darcies to 4.0 Darcies) and 6.667 g/L of Clarcel® CBL (water permeability 0.049 Darcies to 0.101 Darcies) were added to the mixture and agitation was performed for one hour while maintaining the temperature at 80° C. This mixture was then recycled through the Dicalite coated Choquenet 12 m² press filter with Sefar Fyltris 25080 AM filter cloths at 1400 L/hr for 15 minutes. After the recycle, the tank was passed through the filter at 1350 L/hr. An additional 50 liters of flush water were pushed through the filter and permeate was collected as well. Compression fluid from the filter was not captured.

This twice filtered material was heated to 85° C. and left agitated without temperature control for 14 hours. At this point the material was reheated to 80° C. for a third filtration step.

The heated mixture had 6 kg of Dicalite 4158 added thereto and mixing was performed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1450 L/hr.

Without cleaning the filter, 5.33 g/L of Clarcel® DICS and 6.667 g/L of Clarcel® CBL were added to the mixture and agitation was performed for one hour while maintaining the temperature at 80° C. This mixture was then recycled through the Dicalite coated Choquenet 12 m² press filter with Sefar Fyltris 25080 AM filter cloths at 1600 L/hr for 15 minutes. After the recycle, the tank was passed through the filter at 1700 L/hr. An additional 50 liters of flush water was pushed through the filter and permeate was collected as well. Compression fluid from the filter was not captured.

The triple filtered permeate was cooled to 60° C. and mixed with 83% IPA at a 1:2 ratio, 2 g IPA solution for each g of scleroglucan solution. This precipitated scleroglucan fibers which can be mechanically separated from the bulk solution. In this example, a tromel separator was used to partition the precipitated fibers from the bulk liquid solution.

After recovery of the fibers they were washed with another 0.5 g 83% IPA solution for each 1 g of initial triple filtered permeate scleroglucan solution.

Wash fibers were dried in an ECI dryer with 95° C. hot water for 1 hour and 13 minutes to produce a product with 89.3% dry matter. This material was ground up and sieved to provide powder smaller in size than 250 micron. The final ground scleroglucan material is the beta-glucan material used in the Examples herein.

### Example I-2. Beta-Glucan Preparation from Fermentation

Crude schizophyllan was produced via fermentation using IAM culture collection 9006: C-180. A few grams of material was cultured in multiple steps to generate inoculum for the production fermentation run. Dosing similar nutrients and sugar as the main fermenter, each initial step was run with active oxygen transfer until roughly half the dextrose was consumed. At these small scales, fermentation was more difficult to design and run to precise specifications.

The production fermenter was inoculated with water, nutrients, and substrate as detailed in Table 1. The fermenter was a 15 liter vessel that was 462 mm tall, 202 mm in diameter, and having ellipsoidal heads. To provide mixing, the vessel had an agitator with a Rushton mixing element near the bottom of 128 mm in diameter and two marine agitators higher up that were both 145 mm in diameter. The agitator started at 200 rpm and ramped to 255 rpm over the course of fermentation shown in Table 2. During the fermentation air was supplied at 0.8 VVM (standard volumes of air per volume of liquid per minute) and temperature was controlled to 28° C. Fermentation was stopped after 95 hours with residual dextrose between 1 to 3 g/L. Fermentation ended with some dextrose to avoid unwanted production of enzymes that can consume beta-glucan substrate.

TABLE 1
Production fermenter contents.

| Ingredient | Commercial Product Name | Mass (g) |
|---|---|---|
| Substrate (sugar) | Cargill C*Sweet D 02767 | 470 |
| KH₂PO₄ | KH₂PO₄ | 7 |
| MgSO₄ | MgSO₄ | 10.5 |
| Fava bean flour | CPX55 | 10 |
| Nutrient Blend | Rochette Solulys 048E | 45 |
| | (corn steep water) | |
| Oil | Sunflower Oil | 2.7 |
| AntiFoam | Breviol D102K | 4 |
| Inorganic Nitrogen | NaNO₃ | 45 |
| Water | Water | 9000 |
| Innoculum | Seed train output | 1000 |

TABLE 2
Fermentation characterization.

| | | | Viscosity | BG + | |
|---|---|---|---|---|---|
| | Glucose | | (cP at | biomass | Agitator |
| Hours | (g/L) | pH | 7.3 s⁻¹) | (g/L) | RPM |
| 0 | 26.3 | 4.5 | | | 200 |
| 23 | 21.4 | 4.39 | | | 215 |
| 47 | 13 | 5.33 | 350 | 4.93 | 255 |
| 55 | 11 | 5.45 | 425 | 8.77 | 255 |
| 71 | 5.5 | 5.54 | 1260 | 16.96 | 255 |
| 78.5 | 4.2 | 5.56 | 1320 | 20.16 | 255 |
| 94.5 | 1.6 | 5.66 | 1880 | 27.51 | 255 |

After fermentation was complete, the broth was heat-killed at 95° C. for 5 minutes. The solution was combined while being stirred at 1:1 with 90% IPA (isopropyl alcohol) to precipitate biomass. Using cheese cloth to retain fibers, the excess liquid was drained away from the fibers. The fibers were then blended with a 90% IPA that was 50% of the initial fermentation solution volume. Using cheese cloth and 10 bar of pressure, the fibers were drained of liquid as much as possible. They were then dried at 60° C. to 90% dry matter (10% residual water/IPA). Dried fibers were ground and classified to <500 microns to make crude schizophyllan powder.

Using a 15 liter jacketed fermenter, 15 g/L of crude schizophyllan was heated to 80° C. for one hour. After heating, the material was fed at 70° C. through a lab homogenizer (APV, Lab 2000 model) at 200-250 bar, dropping to 50° C. during processing. After homogenization, the material was diluted to 8 g/L relative to the original dosing.

The material was then passed through a coarse filtration on a Gautier filter (model ALM 2) covered with 25302 AN membranes and jacketed with 85° C. water to target an 80° C. solution temperature inside the filter. To fit the filter, 1.5 liters of diluted broth was mixed with 72 g of Dicalite 4158 filter aid and heated to 80° C. The mixture was put into the Gautier filter and 0.1 to 1 barg of pressure was applied, increasing over the filtration to maintain flow at 20-150 mL/min. After 20% of the original diluted broth passes, the filter was opened back open and the material was put back into the Gautier. At this point, the entire volume was passed through the filter. This filtrate was carried forward to the 2^{nd} filtration step.

The second filtration step used the same filtration equipment setup but with different filter aids. A water mixture of 0.5 liters with 10 grams of Dicalite was run through twice to apply a precoat to the filter. A dose of 5.33 g/L of Clarel® DICS and 6.667 g/L of Clarcel® CBL was added to the coarse filtrate and agitation was performed for one hour while maintaining temperature at 80° C. This mixture was then added to the Gautier and 20% of the volume was passed. This material was put back in the filter housing. At this point the entire volume was passed through filter and 0.1 to 1 barg of pressure was applied, increasing over the filtration to maintain flow at 20-150 mL/min. This filtrate was carried forward to the 3^{rd} filtration step.

The third filtration was a duplication of the second filtration using the second filtrate instead of the coarse filtrate for feed material. The filtrate from this step was carried forward to alcohol precipitation. When working with larger volumes of broth, the three filtration steps can be run multiple times, blending all of the third filtrate material before precipitation.

To precipitate and dry the material, the third filtrate solution was combined while being stirred at 1:1 with 90% IPA (isopropyl alcohol) to precipitate biomass. Using cheese cloth to retain fibers, the excess liquid was drained away from fibers. The fibers were then blended with a 90% IPA that was 50% of the initial fermentation solution volume. Using cheese cloth and 10 bar of pressure, the fibers were drained as much as possible of liquid. Afterwards they were dried in a 60° C. to 90% dry matter (10% residual water/IPA) in an oven (Memmert model ULM 700). Dried fibers were ground and classified to <500 microns to make the beta-glucan material.

### Part II. Properties of Solutions of Beta-Glucan in Sea Water after Shear Treatment

### Example II-1. Preparation of Samples

A solution of 90 wt % butanol and 10 wt % deionized water was prepared. The solution was agitated on a stir plate. The beta-glucan from Example I-1 was added with stirring by hand until all solid appeared wetted and well-incorporated to form a 35 wt % beta-glucan solution.

A synthetic sea water solution was prepared using deionized water and Sigma Aldrich Sea salts (S9883) at 30 g/L salt. Water was agitated on a stir plate, sea salts were added, and agitation was performed until no solids were visible. The water was filtered through a 0.8 micron EMD Millipore Mixed Cellulose Ester filter.

The synthetic sea water was weighted to measure an amount needed to form a solution with the beta-glucan solution having a beta-glucan concentration of 1 g/L. The synthetic sear water was agitated on a stir plate, and the 35 wt % beta-glucan suspension was added. The solution was agitated on the stir plate until no clumps or phase separation were visible. Stir plate shear rate calculation. The shearing elements used were about 2.5-10 cm in diameter with about a 1-2 mm gap between the shearing element and the bottom of the beaker. The shear rate was about 700 rpm. D*π*rpm*(1 min/60 s)=distance travelled of outer edge of shearing element per second, which can be divided by the gap distance to estimate the shear rate. (2.5 to 10 cm)*π*700 rpm*(1 min/60 s)/0.1 to 0.2 cm=about 460 s⁻¹ to about 3,670 s⁻¹.

The solution was fed to IKA® Magic Lab® in UTL configuration with one medium rotor stator. IKA® Magic Lab® is an inline mixer using rotor stator to impart shear on the solution. The term ‘pass’ is used to denote feeding solution to the Magic Lab and collecting it at the discharge, such that one ‘pass’ designates that solution has been processed through the equipment one time. The solution was processed through Magic Lab for 3 passes, through the single rotor stator assembly once each pass. The feed solution was split into thirds with samples prepared at 10,000 rpm, 16,000 rpm, and 20,000 rpm rotor speed settings.

Each pass through the single rotor stator assembly of the Magic Lab subjected the sample to a shear rate (s⁻¹) of about 10 times the rotor speed setting in rpm for a duration of about 0.01 s to about 1 s. Three passes at 10,000 rpm subjected the sample to a shear of about 100,000 s⁻¹ for about 0.03 s to about 3 s. Three passes at 16,000 rpm subjected the sample to a shear of about 160,000 s⁻¹ for about 0.03 s to about 3 s. Three passes at 20,000 rpm subjected the sample to a shear of about 200,000 s⁻¹ for about 0.03 s to about 3 s.

### Example II-2. Characterization of Samples

Viscosity and filterability of the shear-treated solutions from Example II-1 were measured.

To measure viscosity, the sample was allowed to settle or a centrifuge was used to expedite settling. The solution had minimal bubbles before measuring viscosity. Viscosity was measured using a Brookfield LVT viscometer at 30 rpm and 21-23° C. Viscosity was measured before AP25 and 1.2 μm filtration that occurs during Filterability Ratio determination.

Filterability Ratio determination. The procedure was carried out before any microbe formation in the solution which could negatively impact the Filterability Ratio. A Pall stainless steel filter housing (4280) was assembled with a 47 mm diameter Millipore AP25 filter (AP2504700). The dispersion of the beta-glucan suspension in synthetic sea water was passed through the housing using a flow rate of 100-300 mL/min, and the filtered dispersion was used for future steps. The Pall stainless steel filter housing (4280) was assembled with 47 mm diameter, 1.2 μm pore size, EMD Millipore mixed cellulose esters filter (part #RAWPO4700), with >200 mL of solution. A container was placed on a mass balance for recording mass of material passing through the filter. Pressure was applied to the filter. The filter was unplugged and pressure was adjusted to achieve a target flux of 1-3 g/s. Once target flux was established, a constant pressure was maintained and the time needed to filter 60 g, 80 g, 160 g, and 180 g of solution through the filter was measured. Filterability Ratio was determined as (time (180 g)−time (160 g))/(time (80 g)−time (60 g)). The elapsed time between the assembly of the Pall stainless steel filter with >200 mL of solution and the time to complete the passing of the 180 g solution through the filter took between 30 minutes and 4 hours.

Viscosity and filterability were measured. Viscosity results are given in Table 3. Filterability Ratio results are given in Table 4.

TABLE 3
Viscosity of samples processed at 10K, 16K, and 20K rpm.

| | 6 rpm | Viscosity | 12 rpm | Viscosity | 30 rpm | Viscosity | 60 rpm | Viscosity |
|---|---|---|---|---|---|---|---|---|
| Sample Description | Reading | (cps) | Reading | (cps) | Reading | (cps) | Reading | (cps) |
| 3 Passes 10K Magic Lab | 10 | 100 | 19 | 95 | 34 | 68 | 42.5 | 42.5 |
| 3 Passes 10K Magic Lab and | 9 | 90 | 16.5 | 82.5 | 34 | 68 | 42.5 | 42.5 |
| AP25 and 1.2 μm filtration | | | | | | | | |
| 3 Passes 16K Magic Lab | 9 | 90 | 16.5 | 82.5 | 32 | 64 | 41.5 | 41.5 |
| 3 Passes 16K Magic Lab after | 8.5 | 85 | 17.5 | 87.5 | 31.5 | 63 | 41.5 | 41.5 |
| AP25 and 1.2 μm filtration | | | | | | | | |
| 3 Passes 20K Magic Lab | 5 | 50 | 14 | 70 | 29 | 58 | 38.5 | 38.5 |
| 3 Passes 20K Magic Lab Pass | 6 | 60 | 13 | 65 | 29 | 58 | 38 | 38 |
| and AP25 and 1.2 μm filtration | | | | | | | | |

TABLE 4
Filterability Ratio of samples processed
at 6K, 16K, and 26K rpm.

| Sample description | Filterability Ratio |
|---|---|
| 3 Passes 10K Magic Lab | 1.25 |
| 3 Passes 16K Magic Lab | 1.17 |
| 3 Passes 20K Magic Lab | 1.08 |

The viscosity data in Table 3 demonstrates that the viscosity was higher for the samples processed with a lower shear. Table 4 demonstrates that the samples had acceptable filtration ratios that were not dramatically impacted by different amounts of Magic Lab shear treatment.

The terms and expressions that have been employed are used as terms of description and not of limitation, and there is no intention in the use of such terms and expressions of excluding any equivalents of the features shown and described or portions thereof, but it is recognized that various modifications are possible within the scope of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of the present invention.

### Exemplary Aspects.

The following exemplary aspects are provided, the numbering of which is not to be construed as designating levels of importance:

Aspect 1 provides a beta-glucan composition comprising:

a beta-glucan; and

water;

wherein shearing the beta-glucan composition at a shear rate of up to a maximum shear rate of about 300,000 s⁻¹ or less provides a sheared beta-glucan composition comprising

a viscosity at standard temperature and pressure at 6 rpm of at least about 30 cps, and

a Filterability Ratio of less or equal to than about 1.5.

Aspect 2 provides the beta-glucan composition of Aspect 1, wherein the shearing of the beta-glucan composition at the shear rate up to the maximum shear rate comprises shearing the beta-glucan composition at a shear rate equal to the maximum shear rate.

Aspect 3 provides the beta-glucan composition of any one of Aspects 1-2, wherein the shearing of the beta-glucan composition at the shear rate up to the maximum shear rate comprises shearing the beta-glucan composition at a shear rate of about 40,000 s⁻¹ to about 300,000 s⁻¹.

Aspect 4 provides the beta-glucan composition of any one of Aspects 1-3, wherein the shearing of the beta-glucan composition at the shear rate up to the maximum shear rate comprises shearing the beta-glucan composition at a shear rate of about 50,000 s⁻¹ to about 250,000 s⁻¹.

Aspect 5 provides the beta-glucan composition of any one of Aspects 1-4, wherein the shearing of the beta-glucan composition at the shear rate up to the maximum shear rate comprises shearing the beta-glucan composition at a shear rate of about 100,000 s⁻¹ to about 200,000 s⁻¹.

Aspect 6 provides the beta-glucan composition of any one of Aspects 1-5, wherein the shearing is performed for a duration of at least 0.001 seconds.

Aspect 7 provides the beta-glucan composition of any one of Aspects 1-6, wherein the shearing is performed for less than 5 seconds.

Aspect 8 provides the beta-glucan composition of any one of Aspects 1-7, wherein the shearing is performed for a duration of about 0.001 seconds to about 60 seconds.

Aspect 9 provides the beta-glucan composition of any one of Aspects 1-8, wherein the shearing is performed for a duration of about 0.01 second to about 5 seconds.

Aspect 10 provides the beta-glucan composition of any one of Aspects 1-9, wherein the shearing is performed at a temperature of about 0° C. to about 150° C.

Aspect 11 provides the beta-glucan composition of any one of Aspects 1-10, wherein the shearing is performed at a temperature of about 20° C. to about 50° C.

Aspect 12 provides the beta-glucan composition of any one of Aspects 1-11, wherein the shearing is performed at a pressure of about 0.1 MPa to about 100 MPa.

Aspect 13 provides the beta-glucan composition of any one of Aspects 1-12, wherein the shearing is performed at a pressure of about 0.1 MPa to about 1 MPa.

Aspect 14 provides the beta-glucan composition of any one of Aspects 1-13, wherein the sheared beta-glucan composition comprises

a viscosity at standard temperature and pressure at 6 rpm of about 30 cps to about 150 cps, and

a Filterability Ratio of about 1.01 to about 1.5.

Aspect 15 provides the beta-glucan composition of any one of Aspects 1-14, wherein the sheared beta-glucan composition comprises

a viscosity at standard temperature and pressure at 6 rpm of at least about 50 cps, and

a Filterability Ratio of less than or equal to about 1.3.

Aspect 16 provides the beta-glucan composition of any one of Aspects 1-15, wherein the sheared beta-glucan composition comprises

a viscosity at standard temperature and pressure at 6 rpm of about 50 cps to about 100 cps, and

a Filterability Ratio of about 1.08 to about 1.25.

Aspect 17 provides the beta-glucan composition of any one of Aspects 1-16, wherein the viscosity and Filterability Ratio are measured after the application of the maximum shear rate and prior to any filtration of the beta-glucan composition.

Aspect 18 provides the beta-glucan composition of any one of Aspects 1-17, wherein the maximum shear rate is about 150,000 s⁻¹ to about 250,000 s⁻¹.

Aspect 19 provides the beta-glucan composition of Aspect 18, wherein the maximum shear rate is about 200,000 s⁻¹.

Aspect 20 provides the beta-glucan composition of any one of Aspects 18-19, wherein the sheared beta-glucan composition comprises

a viscosity at standard temperature and pressure at 6 rpm of about 30 cps to about 80 cps, and

a Filterability Ratio of about 1.1 to about 1.5.

Aspect 21 provides the beta-glucan composition of any one of Aspects 18-20, wherein the sheared beta-glucan composition comprises

a viscosity at standard temperature and pressure at 6 rpm of about 40 cps to about 60 cps, and

a Filterability Ratio of about 1.2 to about 1.3.

Aspect 22 provides the beta-glucan composition of any one of Aspects 1-21, wherein the maximum shear rate is about 110,000 s⁻¹ to about 210,000 s⁻¹.

Aspect 23 provides the beta-glucan composition of Aspect 22, wherein the maximum shear rate is about 160,000 s⁻¹.

Aspect 24 provides the beta-glucan composition of any one of Aspects 22-23, wherein the sheared beta-glucan composition comprises

a viscosity at standard temperature and pressure at 6 rpm of about 60 cps to about 120 cps, and

a Filterability Ratio of about 1.1 to about 1.3.

Aspect 25 provides the beta-glucan composition of any one of Aspects 22-24, wherein the sheared beta-glucan composition comprises

a viscosity at standard temperature and pressure at 6 rpm of about 80 cps to about 100 cps, and

a Filterability Ratio of about 1.15 to about 1.25.

Aspect 26 provides the beta-glucan composition of any one of Aspects 1-25, wherein the maximum shear rate is about 50,000 s⁻¹ to about 150,000 s⁻¹.

Aspect 27 provides the beta-glucan composition of Aspect 26, wherein the maximum shear rate is about 100,000 s⁻¹.

Aspect 28 provides the beta-glucan composition of any one of Aspects 26-27, wherein the sheared beta-glucan composition comprises

a viscosity at standard temperature and pressure at 6 rpm of about 70 cps to about 130 cps, and

a Filterability Ratio of about 1 to about 1.2.

Aspect 29 provides the beta-glucan composition of any one of Aspects 26-28, wherein the sheared beta-glucan composition comprises

a viscosity at standard temperature and pressure at 6 rpm of about 90 cps to about 110 cps, and

a Filterability Ratio of about 1.05 to about 1.15.

Aspect 30 provides the beta-glucan composition of any one of Aspects 1-29, wherein the water and the beta-glucan are homogeneous in the beta-glucan composition.

Aspect 31 provides the beta-glucan composition of any one of Aspects 1-30, wherein the beta-glucan is about 0.001 wt % to about 10 wt % of the beta-glucan composition.

Aspect 32 provides the beta-glucan composition of any one of Aspects 1-31, wherein the beta-glucan is about 0.01 wt % to about 3 wt % of the beta-glucan composition.

Aspect 33 provides the beta-glucan composition of any one of Aspects 1-32, wherein the beta-glucan is a 1,3 beta-glucan.

Aspect 34 provides the beta-glucan composition of any one of Aspects 1-33, wherein the beta-glucan is a 1,3-1,6 beta-D-glucan.

Aspect 35 provides the beta-glucan composition of any one of Aspects 1-34, wherein the beta-glucan is a 1,3-1,4 beta-D-glucan.

Aspect 36 provides the beta-glucan composition of any one of Aspects 1-35, wherein the beta-glucan is scleroglucan.

Aspect 37 provides the beta-glucan composition of any one of Aspects 1-36, wherein the beta-glucan is schizophyllan.

Aspect 38 provides the beta-glucan composition of any one of Aspects 1-37, wherein the beta-glucan has a particle size of about 10 microns to about 1,000 microns.

Aspect 39 provides the beta-glucan composition of any one of Aspects 1-38, wherein the beta-glucan has a particle size of about 100 microns to about 500 microns.

Aspect 40 provides the beta-glucan composition of any one of Aspects 1-39, wherein the water is about 70 wt % to about 99.999 wt % of the beta-glucan composition.

Aspect 41 provides the beta-glucan composition of any one of Aspects 1-40, wherein the water is about 95 wt % to about 99.99 wt % of the beta-glucan composition.

Aspect 42 provides the beta-glucan composition of any one of Aspects 1-41, wherein the water comprises fresh water, salt water, brine, produced water, flowback water, brackish water, sea water, synthetic sea water, or a combination thereof.

Aspect 43 provides the beta-glucan composition of any one of Aspects 1-42, wherein the water has a salt concentration of 1,000 ppm to about 300,000 ppm.

Aspect 44 provides the beta-glucan composition of any one of Aspects 1-43, wherein the water comprises NaBr, CaCl₂, CaBr₂, ZnBr₂, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof.

Aspect 45 provides the beta-glucan composition of any one of Aspects 1-44, further comprising one or more organic solvents.

Aspect 46 provides the beta-glucan composition of any one of Aspects 1-45, wherein the one or more organic solvents comprise an alcohol, an alpha-hydroxy acid alkyl ester, a polyalkylene glycol alkyl ether, or a combination thereof.

Aspect 47 provides the beta-glucan composition of any one of Aspects 45-46, wherein the one or more organic solvents are about 0.001 wt % to about 30 wt % of the beta-glucan composition.

Aspect 48 provides the beta-glucan composition of any one of Aspects 45-47, wherein the one or more organic solvents are about 0.01 wt % to about 5 wt % of the beta-glucan composition.

Aspect 49 provides the beta-glucan composition of any one of Aspects 45-48, wherein the one or more organic solvents are miscible with the water in the beta-glucan composition.

Aspect 50 provides a sheared beta-glucan composition formed by shearing the beta-glucan composition of any one of Aspects 1-49 at less than or equal to the maximum shear rate.

Aspect 51 provides a beta-glucan composition comprising:

a beta-glucan that is scleroglucan, schizophyllan, or a combination thereof, having a particle size of about 100 microns to about 500 microns, wherein the beta-glucan is about 0.01 wt % to about 3 wt % of the beta-glucan composition; and

water that is about 95 wt % to about 99.99 wt % of the beta-glucan composition, wherein the water and the beta-glucan are homogeneous;

wherein shearing the beta-glucan composition at a shear rate of about 50,000 s⁻¹ to about 250,000 s⁻¹ for a duration of at least 0.01 s provides a sheared beta-glucan composition comprising

a viscosity at standard temperature and pressure at 6 rpm of about 30 cps to about 150 cps, and

a Filterability Ratio of about 1.01 to about 1.5.

Aspect 52 provides a prepared beta-glucan composition, the prepared beta-glucan composition comprising:

a beta-glucan; and

water;

a viscosity at standard temperature and pressure at 6 rpm of at least about 30 cps, and

a Filterability Ratio of less or equal to than about 1.5.

Aspect 53 provides the prepared beta-glucan composition of Aspect 52, wherein the prepared beta-glucan composition is the sheared beta-glucan composition of Aspect 50.

Aspect 54 provides a method of treating a subterranean formation, the method comprising:

placing the beta-glucan composition of any one of Aspects 1-49 in the subterranean formation.

Aspect 55 provides a method of treating a subterranean formation, the method comprising:

placing the prepared beta-glucan composition of any one of Aspects 50 and 52 in the subterranean formation.

Aspect 56 provides the method of Aspect 55, wherein placing the prepared beta-glucan composition in the subterranean formation comprises:

placing the beta-glucan composition of any one of Aspects 1-49 in the subterranean formation and shearing the beta-glucan composition to form the sheared beta-glucan composition of any one of Aspects 1-49 in the subterranean formation,

shearing the beta-glucan composition of any one of Aspects 1-49 above-surface to form the sheared beta-glucan composition of any one of Aspects 1-49 and subsequently placing the sheared beta-glucan composition in the subterranean formation, or

a combination thereof.

Aspect 57 provides the method of Aspect 55, further comprising performing an enhanced oil recovery procedure in the subterranean formation using the prepared beta-glucan composition.

Aspect 58 provides the method of Aspect 57, wherein the enhanced oil recovery procedure comprises polymer flooding.

Aspect 59 provides the method of any one of Aspects 57-58, wherein the prepared beta-glucan composition in the subterranean formation sweeps petroleum in the subterranean formation toward a well.

Aspect 60 provides the method of Aspect 59, comprising removing the petroleum from the well.

Aspect 61 provides a method of forming the prepared beta-glucan composition of Aspect 52, the method comprising:

applying to the beta-glucan composition of any one of Aspects 1-49 a shear rate of less than or equal to the maximum shear rate, to form the sheared beta-glucan composition.

Aspect 62 provides a method of treating a subterranean formation, comprising: performing the method of Aspect 61; and

placing the sheared beta-glucan composition in the subterranean formation.

Aspect 63 provides the method of Aspect 62, wherein the shearing occurs above-surface.

Aspect 64 provides the method of any one of Aspects 62-63, wherein the shearing occurs downhole.

Aspect 65 provides the method of any one of Aspects 62-64, further comprising:

determining permeability of the subterranean formation;

selecting the maximum shear rate to correspond to a Filterability Ratio that corresponds to the determined permeability.

Aspect 66 provides the method of any one of Aspects 62-65, further comprising performing an enhanced oil recovery procedure in the subterranean formation using the prepared beta-glucan composition.

Aspect 67 provides a method of treating a subterranean formation, the method comprising:

placing the prepared beta-glucan composition of Aspect 52 in the subterranean formation; and

maintaining viscosity of the prepared beta-glucan composition comprising applying a shear rate of about 50,000 s⁻¹ to about 250,000 s⁻¹ for a duration of at least 0.01 s.

Aspect 68 provides the method of Aspect 67, wherein the prepared beta-glucan composition placed in the subterranean formation has an original viscosity, wherein the viscosity of the prepared beta-glucan composition in the subterranean formation is maintained within about 50% to about 100% of the original viscosity.

Aspect 69 provides the method of any one of Aspects 67-68, wherein the viscosity of the prepared beta-glucan composition in the subterranean formation is maintained to about 30 cps to about 150 cps as measured at standard temperature and pressure at 6 rpm.

Aspect 70 provides the method of any one of Aspects 67-69, wherein the maintaining of the viscosity further comprises maintaining the Filterability Ratio of the prepared beta-glucan composition.

Aspect 71 provides the method of Aspect 70, wherein the prepared beta-glucan composition placed in the subterranean formation has an original Filterability Ratio, wherein the Filterability Ratio of the prepared beta-glucan composition in the subterranean ratio is maintained within about 50% to about 100% of the original filterability ratio.

Aspect 72 provides the method of any one of Aspects 70-71, wherein the Filterability Ratio of the prepared beta-glucan composition in the subterranean formation is maintained to about 1.01 to about 1.5.

Aspect 73 provides the use of the beta-glucan composition of any one of Aspects 1-49 for treatment of a subterranean formation.

Aspect 74 provides the use of the sheared beta-glucan composition of Aspect 50 or the prepared beta-glucan composition of Aspect 52 for treatment of a subterranean formation.

Aspect 75 provides the composition, method, or use of any one or any combination of Aspects 1-74 optionally configured such that all elements or options recited are available to use or select from.

1. A beta-glucan composition comprising:
a beta-glucan; and
water;
wherein shearing the beta-glucan composition at a shear rate of up to a maximum shear rate of about 300,000 s⁻¹ or less provides a sheared beta-glucan composition comprising
a viscosity at standard temperature and pressure at 6 rpm of at least about 30 cps, and
a Filterability Ratio of less or equal to than about 1.5.

2. The beta-glucan composition of claim 1, wherein the shearing of the beta-glucan composition at the shear rate up to the maximum shear rate comprises shearing the beta-glucan composition at a shear rate equal to the maximum shear rate.

3. The beta-glucan composition of claim 1, wherein the shearing of the beta-glucan composition at the shear rate up to the maximum shear rate comprises shearing the beta-glucan composition at a shear rate of about 40,000 s⁻¹ to about 300,000 s⁻¹.

4. The beta-glucan composition of claim 1, wherein the shearing of the beta-glucan composition at the shear rate up to the maximum shear rate comprises shearing the beta-glucan composition at a shear rate of about 50,000 s⁻¹ to about 250,000 s⁻¹.

5. The beta-glucan composition of claim 1, wherein the shearing of the beta-glucan composition at the shear rate up to the maximum shear rate comprises shearing the beta-glucan composition at a shear rate of about 100,000 s⁻¹ to about 200,000 s⁻¹.

6. The beta-glucan composition of claim 1, wherein the shearing is performed for a duration of at least 0.001 seconds.

7. The beta-glucan composition of claim 1, wherein the shearing is performed for less than 5 seconds.

8. The beta-glucan composition of claim 1, wherein the shearing is performed for a duration of about 0.001 seconds to about 60 seconds.

9. The beta-glucan composition of claim 1, wherein the shearing is performed for a duration of about 0.01 second to about 5 seconds.

10. The beta-glucan composition of claim 1, wherein the shearing is performed at a temperature of about 0° C. to about 150° C.

11. The beta-glucan composition of claim 1, wherein the shearing is performed at a temperature of about 20° C. to about 50° C.

12. The beta-glucan composition of claim 1, wherein the shearing is performed at a pressure of about 0.1 MPa to about 100 MPa.

13. The beta-glucan composition of claim 1, wherein the shearing is performed at a pressure of about 0.1 MPa to about 1 MPa.

14. The beta-glucan composition of claim 1, wherein the sheared beta-glucan composition comprises
a viscosity at standard temperature and pressure at 6 rpm of about 30 cps to about 150 cps, and
a Filterability Ratio of about 1.01 to about 1.5.

15. The beta-glucan composition of claim 1, wherein the sheared beta-glucan composition comprises
a viscosity at standard temperature and pressure at 6 rpm of at least about 50 cps, and
a Filterability Ratio of less than or equal to about 1.3.

16.-74. (canceled)
